(19) United States
(12) Patent Application Publication
(10) Pub. No.: US 2025/0356248 A1
(43) Pub. Date: Nov. 20, 2025

(54) GENERATION OF DETERMINATIVE ACTION POLICIES

(71) Applicant: Salesforce, Inc., San Francisco, CA (US)

(72) Inventors: Nathaniel Price, San Francisco, CA (US); Robert Van Osten, Chandler, AZ (US); Sean Lynch, San Francisco, CA (US); Joseph Chrzanowski, Lakewood, CO (US); Adam Evans, San Francisco, CA (US); Kristian Muñiz Feliciano, Lancaster, MA (US); Cameron Kennedy, San Francisco, CA (US)

(21) Appl. No.: 18/667,233

(22) Filed: May 17, 2024

(51) Int. Cl. G06N 20/00

(52) U.S. Cl. CPC G06N 20/00

(57) ABSTRACT

Methods, apparatuses, and computer-program products are disclosed. The method may include transmitting, to a first generative artificial intelligence (AI) model, a request to convert a natural language description of a generative AI behavioral policy into a pseudo-code expression of the generative AI behavioral policy, where the generative AI behavioral policy describes conditions and actions to be performed based on the conditions; transmitting, to a second generative AI model, a prompt generated based on the pseudo-code expression of the generative AI behavioral policy, a user request, and an instruction that the second generative AI model is to generate a response to the user request; and receiving, from the second generative AI model and based on the prompt, an output of the second generative AI model and the output conforms with the user request and the pseudo-code expression of the generative AI behavioral policy.

### FIELD OF TECHNOLOGY

The present disclosure relates generally to database systems and data processing, and more specifically to generation of determinative action policies.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may utilize a generative artificial intelligence (AI) model to produce output in response to an input.

### BRIEF DESCRIPTION OF THE DRAWINGS

FIG. 1 illustrates an example of a data processing system that supports generation of determinative action policies in accordance with examples as disclosed herein.

FIG. 2 shows an example of a system that supports generation of determinative action policies in accordance with examples as disclosed herein.

FIG. 3 shows an example of a process flow that supports generation of determinative action policies in accordance with examples as disclosed herein.

FIG. 4 shows a block diagram of an apparatus that supports generation of determinative action policies in accordance with examples as disclosed herein.

FIG. 5 shows a block diagram of a generative AI model manager that supports generation of determinative action policies in accordance with examples as disclosed herein.

FIG. 6 shows a diagram of a system including a device that supports generation of determinative action policies in accordance with examples as disclosed herein.

FIG. 7 shows a flowchart illustrating methods that support generation of determinative action policies in accordance with examples as disclosed herein.

### DETAILED DESCRIPTION

In some cases, generative artificial intelligence (AI) models may be utilized in cloud computing environments. However, these models may encounter difficulties in processing diverse inputs, selecting suitable actions, and managing extensive prompts. Additionally, generative AI models may struggle to identify when they are functioning beyond their designated scope, potentially leading to inaccurate responses and a decrease in user trust. Furthermore, organizations may desire adherence to specific rules and business practices, but generative AI models may not consistently meet these considerations, thereby posing additional obstacles in the implementation of generative AI models in cloud computing environments.

A cloud computing system utilizing a generative AI model may integrate one or more policies for the generative AI models. These policies may state the rules that the generative AI model is to follow in a deterministic manner by encoding the rules in pseudo-code (e.g., which may be generated by the generative AI model itself) which is then passed to the generative AI model in a prompt, which may aid the generative AI model to behave in a more deterministic manner. In some examples, these policies serve as a conduit between the organization's business logic and practices and a codified set of actions, instructions, and data (e.g., expressed in pseudo-code) that can be incorporated into the generative AI model prompts. Policies may have the capacity to add or remove actions, incorporate instructions, and apply conditional logic regarding their activation. This allows for dynamic, real-time modifications to the generative AI model prompt, thereby providing it with the most accurate set of instructions possible.

Additionally, or alternatively, the techniques described herein include dynamic prompting capabilities in connection with policies and topics. This may allow conditional actions to be added or removed from a prompt. This could be achieved by initially classifying the next assistant utterance into one of a discrete set of topics, each containing metadata with instructions and actions. The conditions for these actions may be evaluated prior to the generative AI model execution, and the actions may be incorporated into the prompt accordingly based on the determined topic.

Additionally, or alternatively, aspects of the disclosure propose the generation of policies based on previous interactions. The generated policies may be assessed by an admin who can approve, update, or reject them. This may allow for the creation of standard policies across industries and the measurement of their accuracy or problem resolution when actions are dynamically made available. Aspects of the disclosure are initially described in the context of an environment supporting an on-demand database service. Aspects of the disclosure are then described with reference to a system and a process flow. Aspects of the disclosure are further illustrated by and described with reference to apparatus diagrams, system diagrams, and flowcharts that relate to generation of determinative action policies.

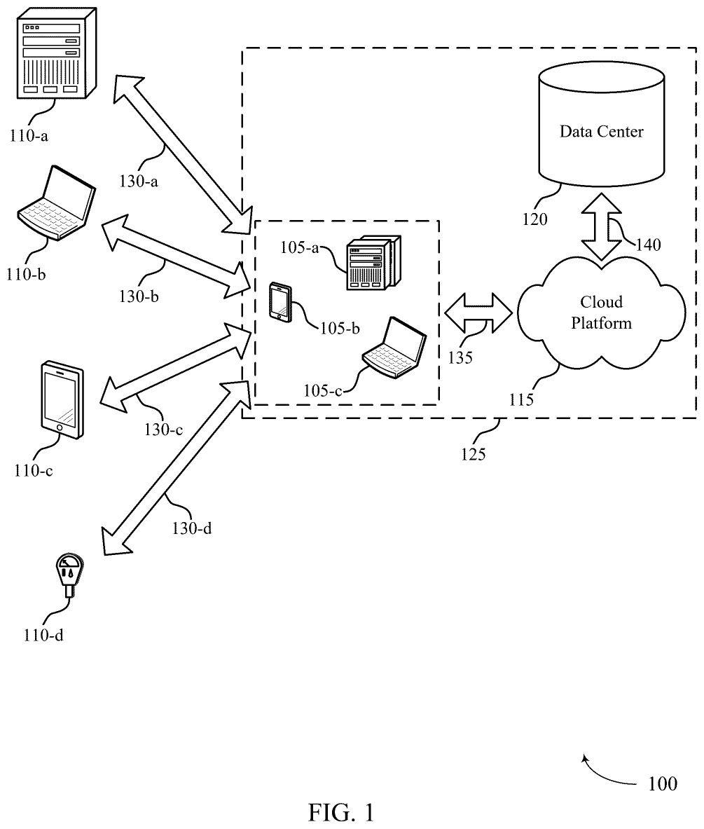

FIG. 1 illustrates an example of a system 100 for cloud computing that supports generation of determinative action policies in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a large language model (generative AI model), such as the generative AI component 145. In some examples, a generative AI component 145 may also be referred to as any of an artificial intelligence (AI), a generative AI (GAI), a GAI model, a large language model (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

For example, a cloud client 105 may transmit a request to generate an output using the generative AI component 145. The cloud platform 115 may receive the request that describes a policy for the generative AI component 145 to implement in operation. The cloud platform 115 may prepare a prompt for the generative AI component 145 to generate a pseudo-code representation of the policy based on the natural language expression of the policy and the generative AI component 145 may return the pseudo-code expression. The cloud platform 115 may generate prompts based on the pseudo-code expression of the policy that include subsequent user requests to generate output. In this way, the generative AI component 145 may better implement the policy in a more determinative manner.

Existing approaches to generative AI models may suffer from slow performance in a conversational setting due to the overhead of generating a full plan of action, and more difficult time recovering from invalid or unexpected input from a user and course correcting. This combination of factors leads to a user experience that would be unacceptable in a customer-facing scenario such as an autonomous customer support chatbot. Further, other approaches to implementing rules, policies, or other “guard rails” for generative AI model operation suffer, as generative AI models may not operate deterministically despite the policies being provided to them.

By encoding the policy into a pseudo-code expression, the generative AI model may better interpret the logical flow of decisions and outcomes inherent in the policy. Further, the pseudo-code expression helps the generative AI model to follow a series of steps and decisions in a more deterministic manner, given the nature of pseudo-code, including logical decisions, decision trees, logical “gates”, and other characteristics of pseudo-code. This pseudo-code provides a bridge or stepping stone between natural language description of policies and the desired deterministic behavior from a generative AI model.

For example, a user may provide a natural language description of a desired policy to be implemented at a generative AI model. The system may convert the natural language description to pseudo code to capture the policy, and the pseudo-code expression may be transmitted to the generative AI model in subsequent prompts to provide a deterministic framework upon which the generative AI model may operate while responding to user inquiries while still upholding the desired policy elements. The user may then receive the output that was generated in compliance with the policy. If one or more parameters of the policy are violated, the generative AI model may indicate such a condition to the user, and may make one or more suggestions to the user (e.g., escalating the situation to a human, trying to redirect the conversation back within the bounds of the policy, or one or more other actions).

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

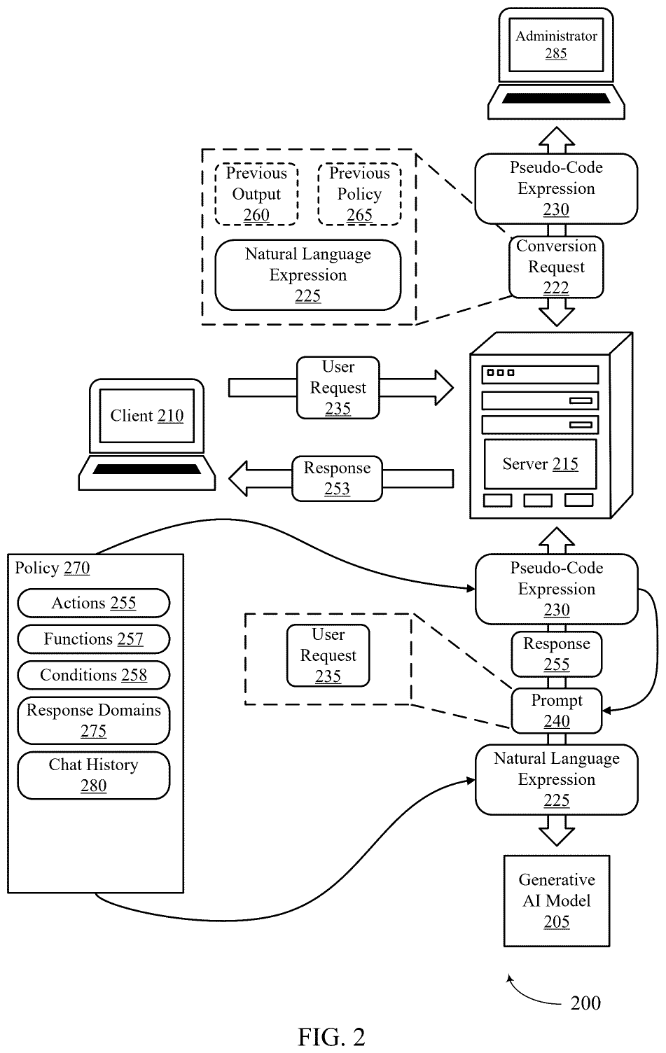

FIG. 2 shows an example of a system 200 that supports generation of determinative action policies in accordance with examples as disclosed herein. The system 200 may include a client 210, a server 215, and a generative AI model 220. The server 215 may represent a single server or processing entity, multiple servers or processing entities, a complete processing system, or any other entity capable of performing the operations described herein. The generative AI model 220 may be included as part of or otherwise associated with the server 215 or may operate independently of the server 215.

In the course of operations, organizations may desire that rules and business practices are followed. While users, organizations, and other may desire to employ generative AI models, inconsistent handling, hallucinations, and “disobedience” of such generative AI models may make the use of generative AI models difficult. To reduce or eliminate such challenges, the system 200 may employ the use of policies, such as the policy 270. Policies provide an additional layer of instructions for enforcing guidelines and rules established by an organization, providing a deterministic way to augment actions available within a generative AI model prompt. For example, policies may encode guidelines and rules established by an organization in a deterministic way through the use of pseudo code (e.g., in the pseudo-code expression 230), which may form a basis for generating a prompt 240 to be interpreted by a generative AI model more deterministically than other inputs. By encoding policy parameters in pseudocode, hallucinations and other errors are reduced. Further, additional functionality for policies may be incorporated. For example, one or more conditions for applying the policy may be employed, and meeting the conditions of the policy may alter prompts given to the generative AI model by adding actions that are made available to the generative AI model based on compliance with the policy. The dynamic prompting that results from policies improve the accuracy of generative AI model 205 responses and allow the generative AI model 205 to resolve problems in a human-relatable way.

In some examples, such policies may be introduced as a sub-component of topics. Such topics may be contextual topics, areas, or other information that guides the responses of the generative AI model into categories or “buckets” (e.g., a response domain 275) within which the generative AI model 205 is to operate. The policies act as the bridge from the organization's business logic and practices (e.g., as represented by topics, for example) to a codified, grounded set of actions, instructions, and data that can be incorporated into the generative AI model prompts, such as the prompt 240. These policies may add or remove actions, instructions, or other information, and may include or indicate conditional logic on when such actions, instructions, or other information are to be invoked. In some examples, the policy 270 conditional logic associated with actions that will determine if an action should be added into a prompt. This conditional logic may include invocable actions that get executed before a prompt is sent to the generative AI model 205. Such invocable actions may modify or augment the prompt 240 based on the conditional logic. This enables dynamic prompting capabilities of policies based on satisfaction of conditions. Thus, such policies may allow for dynamic runtime alterations to the generative AI model prompt 240, giving it the most accurate set of instructions possible.

The policy 270 may be initially expressed in a natural language expression 225 (e.g., written by an administrator, generated by the generative AI model 205 based on another policy or output, such as the previous output 260 or the previous policy 265, or any combination thereof). The policy 270 may also be expressed in a pseudo-code expression 230 which includes or indicated information included or indicated in the natural language expression 225, but expressed is pseudo-code (e.g., optionally including one or more elements of conditional logic that express the policy). In some examples, the policy 270 may be expressed (e.g., whether it be via the pseudo-code expression 230 or the natural language expression 225) via a data object, which may include a plaintext portion and a description portion. The plaintext portion may include or indicate one or more utterances (e.g., the natural language expression of the 225) used to generate the codified policy steps (e.g., the pseudo-code expression 230). The policy description may be a short description that a user or administrator 285 may use to help better manage or organize policies. Such policy descriptions may (but is not required to) be used to generate the prompt 240.

An example may be illustrative. Say that one or more standard actions (e.g., query_record( ), update_record( ), and create_record( )) are available, and one or more custom actions (e.g., initiate_return( ), get_shipping_status( ), order_product( ), and cancel_order( )) are available for use by the system 200. Policies 270 may inform or dictate under what conditions such actions are available to be included in the prompt 240.

For example, the following are example policies that may involve such functions. An e-commerce policy 270 for returns before 30 days may include the following:
Condition: order.purchase_date<30 days
Description: “Returns are accepted within 30 days of purchase”
Actions: [+initiate_return(order: Order)]
Available: true

An e-commerce policy 270 for updating shipping information for an order may include the following:
Condition: order.status==“pending” && order.tracking_number !=null
Description: “Update the shipping information on the Order and Customer”
Actions: [+update_record(record: Record)]
Available: true

An e-commerce policy 270 for in-warrant replacement may include the following:
Condition: order.purchase_date<1 year and product.defect==TRUE
Description: “If the product is unrepairable and still in warranty, issue a replacement product and
Create a ticket logging the outcomes of the warranty replacement”
Actions: [+query_record(product: Product), +order_product(product: Product, customer:
Customer), +update_record(product: Product)]
Available: true

An e-commerce policy 270 for canceling orders may include the following:
Condition: order.status==“pending” && order.tracking_number !=null
Description: “Allow pending orders to be canceled”
Actions: [+cancel_order(order: Order)]
Available: true

In some examples, an administrator 285 or other use may transmit a conversion request 222 to the server 215. The conversion request 222 may indicate that the generative AI model 205 is to convert the natural language expression 225 of the policy 270 to a pseudo-code expression 230 that may be used as at least a partial basis for generating the prompt 240. For example, the pseudo-code expression 230 may be interpreted (e.g., by an evaluation engine, the server 215, or another element of the system 200) to modify or guide parameters, settings, configurations, training data, or other information that the generative AI model 205 may use to process the user request 235 and generate the response 255 (or to perform any other processing, including any processing described here).

In some examples, the conversion request 222 may include or indicate a previous output 260 (e.g., that was generated based on a policy associated with the current policy 270 or based on the same policy 270), a previous policy 265 (e.g., a policy associated or similar to the current policy 270). For example, the previous output 260, the previous policy 265, or both, may provide additional context or information for generating the pseudo-code expression 230 that may improve the quality of the pseudo-code expression 230.

The server 215 may receive the user request 235. The user request 235 may include one or more instructions, queries, or requests for the generative AI model 205 to generate the response 253. For example, the user request 235 may include, indicate, or involve one or more operations to be performed on a cloud computing platform.

The server 215 may process the user request 235 and may generate the prompt 240 based on the user request 235 and the pseudo-code expression 230. For example, the prompt 240 may be augmented or modified based on one or more aspects of the policy, including the actions 255, the functions 257, the response domains 275, the chat history 280, or any combination thereof. For example, the actions 255 may be one or more actions that may be performed by the server 215, the generative AI model 205, or both, based on satisfaction of one or more conditions 258 indicated in the policy 270. In some examples, the prompt 240 may not directly include the pseudo-code expression 230 but may provide guidelines or rules for which actions 255 or functions 257 or other policy elements or indications may be included or indicated in the prompt 240. Additionally, or alternatively, the natural language expression 225, the pseudo-code expression 230, or both, may be included in the prompt 240 to be interpreted directly by the generative AI model 205.

In some examples, policies 270 may provide a basis for adding or removing instructions or actions from the prompt 240. The removal of an instruction may occur if there is an exact or partial match between an instruction indicated for removal in the policy 270. Policies may also have the ability to add or deny actions. If an action is added, the corresponding data considerations should also be incorporated into the prompt 240. However, if multiple policies 270 are being used to generate the prompt 240, and a first policy 270 denies an action, that action may not be available in the final prompt 240, despite the indications of other policies 270 being used. In some examples, policies 270 may also have a control flow, which refers to the logic of when and how a policy 270 should be invoked. This logic may be multi-level and may include exceptions (e.g., based on an identify of the client 210).

For example, assume that multiple such policies 270 have been conditionally met, that each policy may add or remove instructions and add or remove actions, and that removing an action prevents it from occurring in the final prompt, even if another policy adds it (e.g., regardless of the order in which the actions or instructions are added or removed). Thus, given a prompt including instructions A and B and action A0; a first policy indicating instructions +X and +Y and actions +A1 and +A2 (e.g., adding such instructions and actions); a second policy indicating instruction +Z and actions +A3 and −A2 (e.g., adding instruction Z and action A3, and removing action A2), the resulting list of instructions to add includes [X, Y, Z], the list of instructions to remove is [ ], the list of actions to add is [A1, A2, A3], and the list of actions to remove is [A2]. If both the first policy and the second policy are valid, then the final prompt will include instructions A, B, X, Y, and Z, as well as actions A0, A1, and A3. As can be seen, action A2 is not included in the prompt due to the removal of A2 indicated in the second policy, despite A2 being added by the first policy.

The actions 255, the functions 257, or both may include retrieval of information to be included in the prompt, additional processing of information (e.g., to be performed by a cloud platform or the server 215), or any combination thereof. In some examples, the actions 255, the functions 257, or both may be available on a per-response domain 275 basis. For example, some actions 255 or functions 257 may be available for one or more response domains 275, whereas such actions 255 or functions 257 may not be available for other response domains. For example, if a client 210 requests a response that involves processing of sensitive information, but the response domain 275 is that of a low-level FAQ conversation, actions 255 or functions 257 for retrieval or processing of such sensitive information may not be available to the generative AI model 205 and indications of such response 253 or functions 257 may not be included in the prompt 240 or may not influence the contents of the prompt 240.

The conditions 258 may designate one or more triggers, thresholds, or other criteria for permitting the use of the actions 255, functions 257, or any combination thereof. In some examples, the one or more conditions 258 may be evaluated to determine whether any additional instructions or actions are to be added to the prompt. If the conditions 258 are met, then the instructions or actions (e.g., the actions 255 or the functions 257) may be added to or indicated in the prompt.

In some examples, the conditions 258 may involve access to one or more data objects relevant to the user request 235 and that are allowed based on the context or response domain 275. However, in some cases, if such data objects are unavailable, then the system 200 may execute one or more actions to allow access such data objects. For example, the server 215 may prompt the client 210 to provide additional information or context for the data objects or may execute one or more actions to provide access to the data objects. In some examples, the conditions 258 may be subject to one or more depth constraints on conditional logic included or indicated therein.

In some examples, the response domains 275 (e.g., also referred to as topics), may be a subject, scope, or context of interactions (e.g., the interactions) occurring between any of the client 210, the generative AI model 205, the server 215, a cloud platform, one or more other devices or systems, or any combination thereof. Additionally, or alternatively, a topic may be defined by a natural language categorization of jobs, scopes, contexts, or procedures that may guide operation of the system 200. In some examples, a topic includes or indicates metadata containing instructions for the generative AI model 205 for the corresponding topic, one or more actions that may be used to complete those instructions, or both. For example, the system 200 may employ the use of topics, such as the response domain 275, to provide guidance to the generative AI model 205, such as by delimiting use cases that the system 200 may match with a current scenario to accomplish a task requested by the client 210.

In some examples, the policy 270 may be tied to or associated with the response domain 275.

In some examples, the chat history 280 may include or indicate one or more interactions between the client 210, the server 215, the generative AI model 205, one or more other devices or systems, or any combination thereof. Such interactions may include information that may provide context or other information for the prompt 240 that may increase the accuracy or relevance of the response 253 generated by the generative AI model 205 in response to the user request 235. For example, a process may be run to generate policies 270 based on previous interactions (e.g., the chat history 280). Such policies 270 may be assessed (e.g., by the generative AI model 205 or the administrator 285) to approve, update, or deny such policies. In some examples, a quantity of interactions relating to the potential pseudo-code expression 230 may be available and may influence one or more operations for modifying the policy 270. For example, such an indication may aid the administrator 285 in understanding how broad of an effect this policy 270 will have.

In some examples, before transmitting the prompt 240 to the generative AI model 205, the server 215 may validate the prompt 240 to verify that no disallowed actions 255 or functions 257 are included or indicated in the prompt 240 or that no such disallowed actions 255 or functions 257 were used as a basis for any information included in the prompt 240.

After receiving the prompt 240, the generative AI model 205 may generate the response 253 based on the prompt 240, the policy 270, one or more other elements, or any combination thereof. The response 253 may be transmitted to the server 215, which may format the response 253 for presentation or transmission to the client 210.

In some examples, the administrator 285 or other users may have access to a repository of policies 270 and one or more management functions may be available to the administrator 285 or other user to manage the repository of policies 270. Such management functions may include viewing, updating, modifying, augmenting, regeneration, or other operations on the policy 270, the natural language expression 225, the pseudo-code expression 230, or any combination thereof. For example, the administrator 285 may have access to modify one or more elements of the natural language expression 225 before the pseudo-code expression 230 is generated or re-generated. Additionally, or alternatively, the administrator 285 may have access to modify one or more elements of the pseudo-code expression 230 after generation.

In some examples, the policies 270 may involve versioning concepts. For example, the administrator 285 or other user may access different versions of the policy 270, and different versions of the policy 270 may be associated with different response domains 275. In some examples, draft policies 270 may be employed for making edits before updated “final” versions of policies 270 are employed in the system 200. In some examples, in response to a policy 270 being published or made available for use by one or more elements of the system 200, the policy 270 may be audited or validated to ensure that the correct version of the policy 270 is being used.

In some examples, the policy 270 may include or indicate actions, control flows, variables, data considerations of the policy 270, additional generative AI model 205 instructions, or any combination thereof. These instructions may be instructions that are added into the generative AI model prompt 240 before processing.

In some cases, errors in generating the pseudo-code expression 230 may occur and some policies 270 may be unable to be codified (e.g., no pseudo-code expression 230 may be generated) based on available information. For example, if an action indicated in the policy 270 is not available, the system 200 may initiate a default action, such as escalating to a human, creating an error case, or otherwise handle the situation. If a condition cannot be fulfilled, during runtime (e.g., in association with producing the response 253 to the user request 235), a fallback operation may be to implement one or more escalation actions. However, if such errors occur in association with designing the policy 270 or generating the pseudo-code expression 230, the error may be flagged and the generative AI model 205 may be asked for possible alternative pseudo-code expressions 230.

In some examples, one or more policy-based metrics may be generated based on the operation of one or more elements of the system 200. Such metrics may include metrics regarding application of policies 270 within a response domain 275, such as how often a particular policy 270 is invoked within a particular response domain 275, when a policy 270 is applicable, how often it is invoked, modifications made to the policy 270, one or more other metrics, or any combination thereof.

In some examples, the client 210 may request that the generative AI model 205 analyze the policy 270 (be it the natural language expression 225 or the pseudo-code expression 230) and respond to inquiries about the policy 270 from the user. For example, the client 210 transmit a query that asks what actions 255 and functions 257 are available and what conditions 258 may be associated with the actions 255 and functions 257.

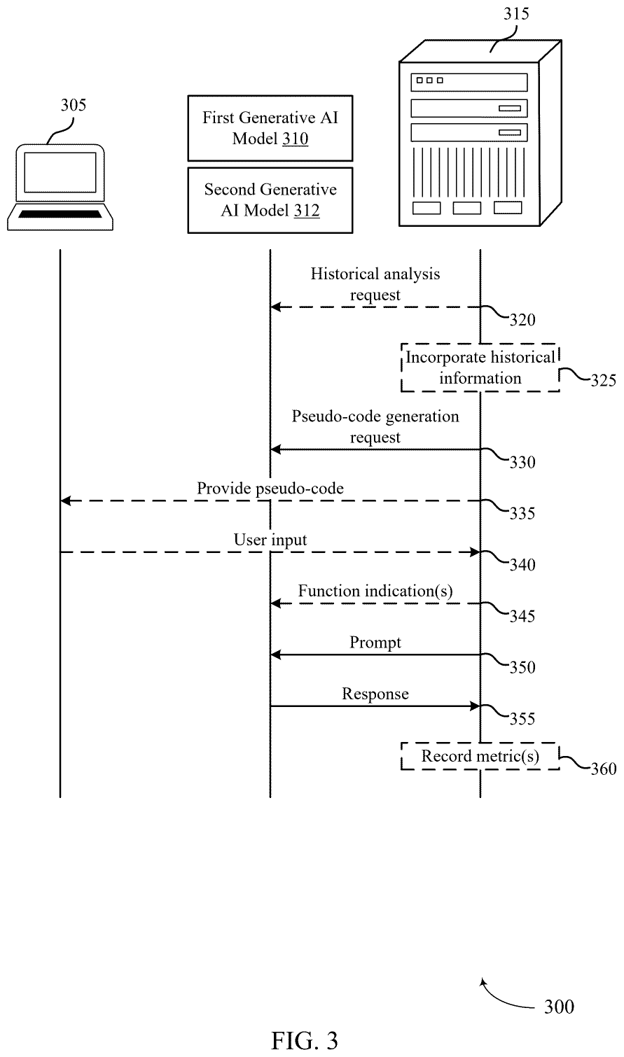

FIG. 3 shows an example of a process flow 300 that supports generation of determinative action policies in accordance with examples as disclosed herein. The process flow 300 may implement various aspects of the present disclosure described herein. The elements described in the process flow 300 (e.g., server 315, first generative AI model 310, second generative AI model 312, and the client 305) may be examples of similarly named elements described herein.

In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 320, the server 315 may transmit, to the second generative AI model 312, a request indicating a previously-generated output of the second generative AI model 312, an operation history associated with generation of the previously-generated output, and an instruction for the second generative AI model 312 to provide an analysis upon which a previously-generated output was based.

At 325, the server 315 may incorporate one or more elements of the analysis into the natural language description of the generative AI behavioral policy.

At 330, the server 315 may transmit, to a first generative artificial intelligence (AI) model, a request to convert a natural language description of a generative AI behavioral policy into a pseudo-code expression of the generative AI behavioral policy and the generative AI behavioral policy describes one or more conditions and one or more actions that are to be performed based on satisfaction of at least one of the one or more conditions, dissatisfaction of at least one of the one or more conditions, or both. In some examples, the generative AI behavioral policy may indicate one or more data inputs associated with the one or more actions. In some examples, the generative AI behavioral policy is associated with one or more response domains, the one or more response domains that may include a knowledge domain, a frequency asked questions domain, a security quarantine domain, an escalation domain, or any combination thereof. In some examples, the pseudo-code expression of the generative AI behavioral policy may include conditional logic statements that correspond with one or more desired behaviors. In some examples, the natural language description of the generative AI behavioral policy may include an interaction history between a user and the first generative AI model 310. In some examples, the pseudo-code expression of the generative AI behavioral policy is based on the interaction history.

At 335, the server 315 may provide (e.g., to the client 305) the pseudo-code expression of the generative AI behavioral policy via a user interface.

At 340, the server 315 may receive (e.g., the client 305) user input modifying the pseudo-code expression of the generative AI behavioral policy.

At 345, the server 315 may provide the second generative AI model 312 with an indication of a plurality of functions and the one or more actions indicated in the pseudo-code expression of the generative AI behavioral policy correspond with one or more functions of the plurality of functions.

At 350, the server 315 may transmit, to a second generative AI model 312, a prompt generated based on the pseudo-code expression of the generative AI behavioral policy, a user request, and an instruction that the second generative AI model 312 is to generate a response to the user request in accordance with the pseudo-code expression of the generative AI behavioral policy. In some examples, the prompt may include an additional instruction that the second generative AI model 312 is to generate the response to the user request in accordance with the one or more response domains. In some examples, the first generative AI model 310 and the second generative AI model 312 are a same generative AI model.

At 355, the server 315 may receive, from the second generative AI model 312 and based on the prompt, an output of the second generative AI model 312 and the output conforms with the user request and the pseudo-code expression of the generative AI behavioral policy. In some examples, the output of the second generative AI model 312 includes one or more function calls to the one or more functions of the plurality of functions.

At 360, the server 315 may record one or more policy-based metrics that indicate a quantity of invocations of the generative AI behavioral policy, a quantity of modifications made to the generative AI behavioral policy, or both.

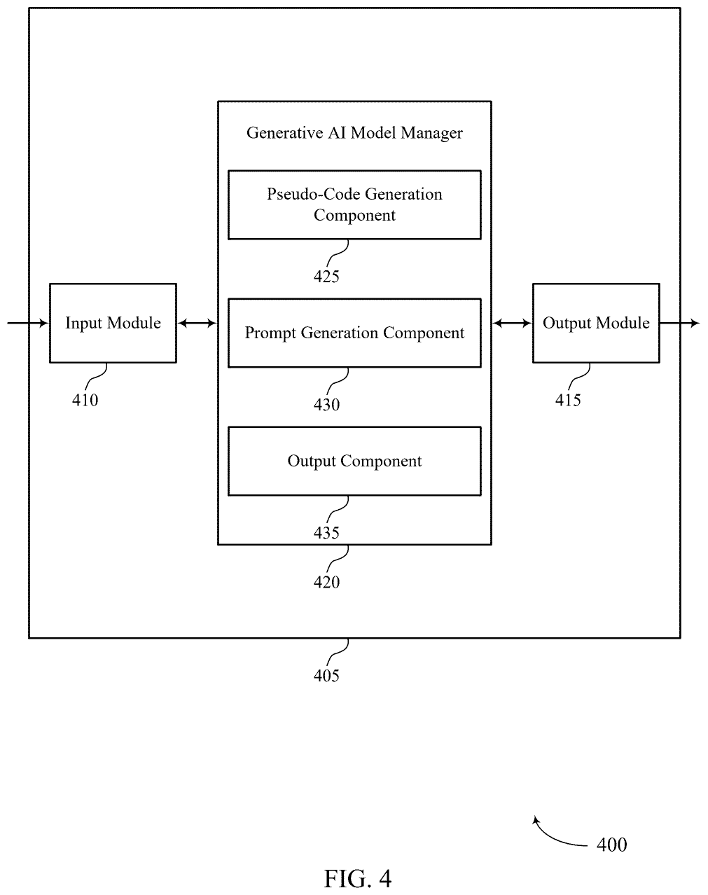

FIG. 4 shows a block diagram 400 of a device 405 that supports generation of determinative action policies in accordance with examples as disclosed herein. The device 405 may include an input module 410, an output module 415, and a generative AI model manager 420. The device 405, or one or more components of the device 405 (e.g., the input module 410, the output module 415, the generative AI model manager 420), may include at least one processor, which may be coupled with at least one memory, to support the described techniques. Each of these components may be in communication with one another (e.g., via one or more buses).

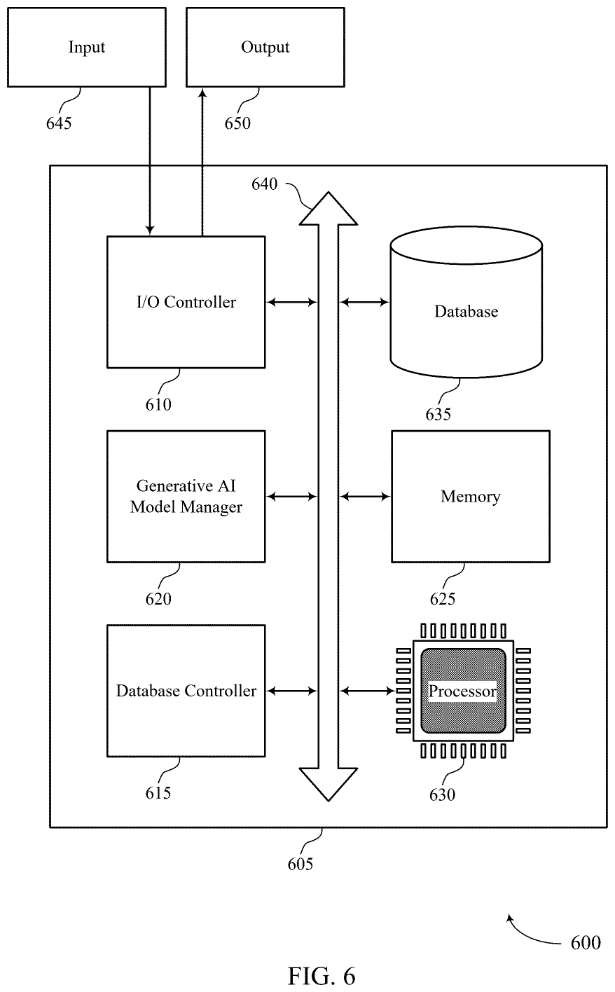

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the generative AI model manager 420 to support generation of determinative action policies. In some cases, the input module 410 may be a component of an input/output (I/O) controller 610 as described with reference to FIG. 6.

The output module 415 may manage output signals for the device 405. For example, the output module 415 may receive signals from other components of the device 405, such as the generative AI model manager 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the generative AI model manager 420 may include a pseudo-code generation component 425, a prompt generation component 430, an output component 435, or any combination thereof. In some examples, the generative AI model manager 420, or various components thereof, may be configured to perform various operations (e.g., receiving, monitoring, transmitting) using or otherwise in cooperation with the input module 410, the output module 415, or both. For example, the generative AI model manager 420 may receive information from the input module 410, send information to the output module 415, or be integrated in combination with the input module 410, the output module 415, or both to receive information, transmit information, or perform various other operations as described herein.

The generative AI model manager 420 may support data processing in accordance with examples as disclosed herein. The pseudo-code generation component 425 may be configured to support transmitting, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both. The prompt generation component 430 may be configured to support transmitting, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy. The output component 435 may be configured to support receiving, from the second generative AI model and based on the prompt, an output of the second generative AI model, where the output conforms with the user request and the pseudo-code expression of the generative AI behavioral policy.

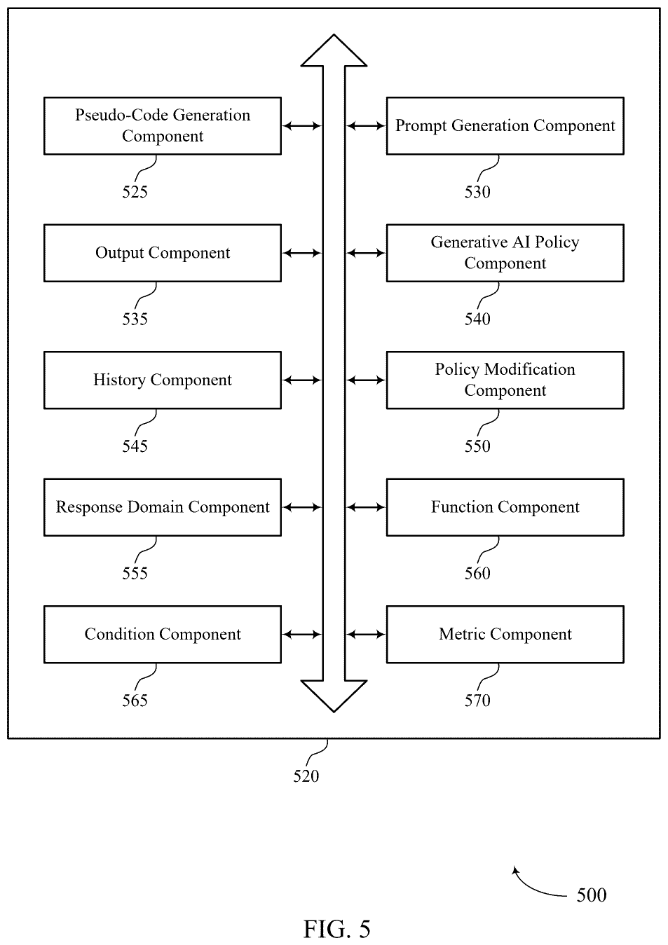

FIG. 5 shows a block diagram 500 of a generative AI model manager 520 that supports generation of determinative action policies in accordance with examples as disclosed herein. The generative AI model manager 520 may be an example of aspects of a generative AI model manager or a generative AI model manager 420, or both, as described herein. The generative AI model manager 520, or various components thereof, may be an example of means for performing various aspects of generation of determinative action policies as described herein. For example, the generative AI model manager 520 may include a pseudo-code generation component 525, a prompt generation component 530, an output component 535, a generative AI policy component 540, a history component 545, a policy modification component 550, a response domain component 555, a function component 560, a condition component 565, a metric component 570, or any combination thereof. Each of these components, or components of subcomponents thereof (e.g., one or more processors, one or more memories), may communicate, directly or indirectly, with one another (e.g., via one or more buses).

The generative AI model manager 520 may support data processing in accordance with examples as disclosed herein. The pseudo-code generation component 525 may be configured to support transmitting, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both. The prompt generation component 530 may be configured to support transmitting, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy. The output component 535 may be configured to support receiving, from the second generative AI model and based on the prompt, an output of the second generative AI model, where the output conforms with the user request and the pseudo-code expression of the generative AI behavioral policy.

In some examples, the generative AI behavioral policy indicates one or more data inputs associated with the one or more actions.

In some examples, the history component 545 may be configured to support transmitting, to the second generative AI model, a request indicating a previously-generated output of the second generative AI model, an operation history associated with generation of the previously-generated output, and an instruction for the second generative AI model to provide an analysis upon which a previously-generated output was based. In some examples, the history component 545 may be configured to support incorporating one or more elements of the analysis into the natural language description of the generative AI behavioral policy.

In some examples, the policy modification component 550 may be configured to support providing the pseudo-code expression of the generative AI behavioral policy via a user interface. In some examples, the policy modification component 550 may be configured to support receiving user input modifying the pseudo-code expression of the generative AI behavioral policy.

In some examples, the generative AI behavioral policy is associated with one or more response domains, the one or more response domains including a knowledge domain, a frequency asked questions domain, a security quarantine domain, an escalation domain, or any combination thereof. In some examples, the prompt is further based on an additional instruction that the second generative AI model is to generate the response to the user request in accordance with the one or more response domains.

In some examples, the function component 560 may be configured to support providing the second generative AI model with an indication of a set of multiple functions, where the one or more actions indicated in the pseudo-code expression of the generative AI behavioral policy correspond with one or more functions of the set of multiple functions.

In some examples, the output of the second generative AI model includes one or more function calls to the one or more functions of the set of multiple functions.

In some examples, the pseudo-code expression of the generative AI behavioral policy includes conditional logic statements that correspond with one or more desired behaviors.

In some examples, the natural language description of the generative AI behavioral policy includes an interaction history between a user and the first generative AI model. In some examples, the pseudo-code expression of the generative AI behavioral policy is based on the interaction history.

In some examples, the metric component 570 may be configured to support recording one or more policy-based metrics that indicate a quantity of invocations of the generative AI behavioral policy, a quantity of modifications made to the generative AI behavioral policy, or both.

In some examples, the first generative AI model and the second generative AI model are a same generative AI model.

FIG. 6 shows a diagram of a system 600 including a device 605 that supports generation of determinative action policies in accordance with examples as disclosed herein. The device 605 may be an example of or include components of a device 405 as described herein. The device 605 may include components for bi-directional data communications including components for transmitting and receiving communications, such as a generative AI model manager 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting generation of determinative action policies). The processor 630 may be an example of a single processor or multiple processors. For example, the device 605 may include one or more processors 630.

The generative AI model manager 620 may support data processing in accordance with examples as disclosed herein. For example, the generative AI model manager 620 may be configured to support transmitting, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both. The generative AI model manager 620 may be configured to support transmitting, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy. The generative AI model manager 620 may be configured to support receiving, from the second generative AI model and based on the prompt, an output of the second generative AI model, where the output conforms with the user request and the pseudo-code expression of the generative AI behavioral policy.

By including or configuring the generative AI model manager 620 in accordance with examples as described herein, the device 605 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

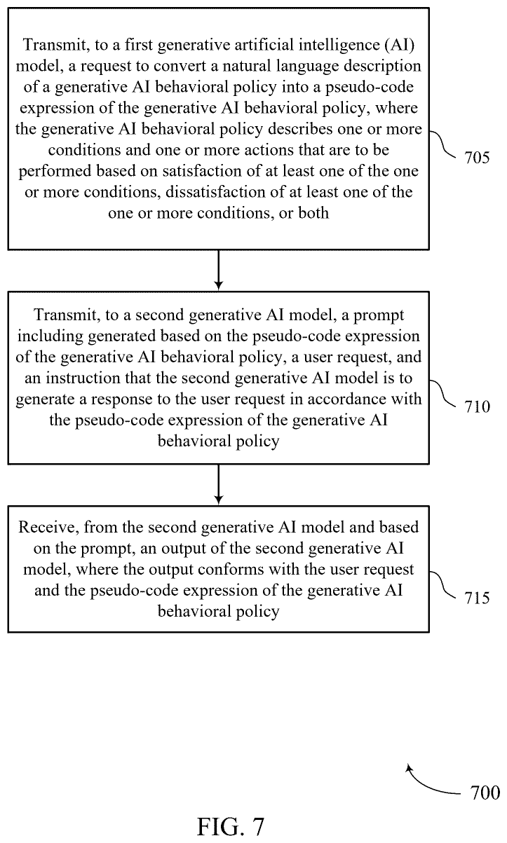

FIG. 7 shows a flowchart illustrating a method 700 that supports generation of determinative action policies in accordance with examples as disclosed herein. The operations of the method 700 may be implemented by an application server or its components as described herein. For example, the operations of the method 700 may be performed by an application server as described with reference to FIGS. 1 through 6. In some examples, an application server may execute a set of instructions to control the functional elements of the application server to perform the described functions. Additionally, or alternatively, the application server may perform aspects of the described functions using special-purpose hardware.

At 705, the method may include transmitting, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both. The operations of 705 may be performed in accordance with examples as disclosed herein. In some examples, aspects of the operations of 705 may be performed by a pseudo-code generation component 525 as described with reference to FIG. 5.

At 710, the method may include transmitting, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy. The operations of 710 may be performed in accordance with examples as disclosed herein. In some examples, aspects of the operations of 710 may be performed by a prompt generation component 530 as described with reference to FIG. 5.

At 715, the method may include receiving, from the second generative AI model and based on the prompt, an output of the second generative AI model, where the output conforms with the user request and the pseudo-code expression of the generative AI behavioral policy. The operations of 715 may be performed in accordance with examples as disclosed herein. In some examples, aspects of the operations of 715 may be performed by an output component 535 as described with reference to FIG. 5.

A method for data processing by an apparatus is described. The method may include transmitting, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both, transmitting, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy, and receiving, from the second generative AI model and based on the prompt, an output of the second generative AI model, where the output conforms with the user request and the pseudo-code expression of the generative AI behavioral policy.

An apparatus for data processing is described. The apparatus may include one or more memories storing processor executable code, and one or more processors coupled with the one or more memories. The one or more processors may individually or collectively be operable to execute the code to cause the apparatus to transmit, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both, transmit, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy, and receive, from the second generative AI model and based on the prompt, an output of the second generative AI model, where the output conforms with the user request and the pseudo-code expression of the generative AI behavioral policy.

Another apparatus for data processing is described. The apparatus may include means for transmitting, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both, means for transmitting, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy, and means for receiving, from the second generative AI model and based on the prompt, an output of the second generative AI model, where the output conforms with the user request and the pseudo-code expression of the generative AI behavioral policy.

A non-transitory computer-readable medium storing code for data processing is described. The code may include instructions executable by one or more processors to transmit, to a first generative artificial intelligence (AI) model, a request to convert a natural language description of a generative AI behavioral policy into a pseudo-code expression of the generative AI behavioral policy, where the generative AI behavioral policy describes one or more conditions and one or more actions that are to be performed based on satisfaction of at least one of the one or more conditions, dissatisfaction of at least one of the one or more conditions, or both, transmit, to a second generative AI model, a prompt generated based on the pseudo-code expression of the generative AI behavioral policy, a user request, and an instruction that the second generative AI model is to generate a response to the user request in accordance with the pseudo-code expression of the generative AI behavioral policy, and receive, from the second generative AI model and based on the prompt, an output of the second generative AI model, where the output conforms with the user request and the pseudo-code expression of the generative AI behavioral policy.

In some examples of the method, apparatus, and non-transitory computer-readable medium described herein, the generative AI behavioral policy indicates one or more data inputs associated with the one or more actions.

Some examples of the method, apparatus, and non-transitory computer-readable medium described herein may further include operations, features, means, or instructions for transmitting, to the second generative AI model, a request indicating a previously-generated output of the second generative AI model, an operation history associated with generation of the previously-generated output, and an instruction for the second generative AI model to provide an analysis upon which a previously-generated output was based and incorporating one or more elements of the analysis into the natural language description of the generative AI behavioral policy.

Some examples of the method, apparatus, and non-transitory computer-readable medium described herein may further include operations, features, means, or instructions for providing the pseudo-code expression of the generative AI behavioral policy via a user interface and receiving user input modifying the pseudo-code expression of the generative AI behavioral policy.

In some examples of the method, apparatus, and non-transitory computer-readable medium described herein, the generative AI behavioral policy may be associated with one or more response domains, the one or more response domains including a knowledge domain, a frequency asked questions domain, a security quarantine domain, an escalation domain, or any combination thereof and the prompt may be further based on an additional instruction that the second generative AI model may be to generate the response to the user request in accordance with the one or more response domains.

Some examples of the method, apparatus, and non-transitory computer-readable medium described herein may further include operations, features, means, or instructions for providing the second generative AI model with an indication of a set of multiple functions, where the one or more actions indicated in the pseudo-code expression of the generative AI behavioral policy correspond with one or more functions of the set of multiple functions.

In some examples of the method, apparatus, and non-transitory computer-readable medium described herein, the output of the second generative AI model includes one or more function calls to the one or more functions of the set of multiple functions.

In some examples of the method, apparatus, and non-transitory computer-readable medium described herein, the pseudo-code expression of the generative AI behavioral policy includes conditional logic statements that correspond with one or more desired behaviors.

In some examples of the method, apparatus, and non-transitory computer-readable medium described herein, the natural language description of the generative AI behavioral policy includes an interaction history between a user and the first generative AI model and the pseudo-code expression of the generative AI behavioral policy may be based on the interaction history.

Some examples of the method, apparatus, and non-transitory computer-readable medium described herein may further include operations, features, means, or instructions for recording one or more policy-based metrics that indicate a quantity of invocations of the generative AI behavioral policy, a quantity of modifications made to the generative AI behavioral policy, or both.

In some examples of the method, apparatus, and non-transitory computer-readable medium described herein, the first generative AI model and the second generative AI model may be a same generative AI model.

The following provides an overview of aspects of the present disclosure:

Aspect 1: A method for data processing, comprising: transmitting, to a first generative artificial intelligence (AI) model, a request to convert a natural language description of a generative AI behavioral policy into a pseudo-code expression of the generative AI behavioral policy, wherein the generative AI behavioral policy describes one or more conditions and one or more actions that are to be performed based at least in part on satisfaction of at least one of the one or more conditions, dissatisfaction of at least one of the one or more conditions, or both; transmitting, to a second generative AI model, a prompt generated based at least in part on the pseudo-code expression of the generative AI behavioral policy, a user request, and an instruction that the second generative AI model is to generate a response to the user request in accordance with the pseudo-code expression of the generative AI behavioral policy; and receiving, from the second generative AI model and based at least in part on the prompt, an output of the second generative AI model, wherein the output conforms with the user request and the pseudo-code expression of the generative AI behavioral policy.

Aspect 2: The method of aspect 1, wherein the generative AI behavioral policy indicates one or more data inputs associated with the one or more actions.

Aspect 3: The method of any of aspects 1 through 2, further comprising: transmitting, to the second generative AI model, a request indicating a previously-generated output of the second generative AI model, an operation history associated with generation of the previously-generated output, and an instruction for the second generative AI model to provide an analysis upon which a previously-generated output was based; and incorporating one or more elements of the analysis into the natural language description of the generative AI behavioral policy.

Aspect 4: The method of any of aspects 1 through 3, further comprising: providing the pseudo-code expression of the generative AI behavioral policy via a user interface; and receiving user input modifying the pseudo-code expression of the generative AI behavioral policy.

Aspect 5: The method of any of aspects 1 through 4, wherein the generative AI behavioral policy is associated with one or more response domains, the one or more response domains comprising a knowledge domain, a frequency asked questions domain, a security quarantine domain, an escalation domain, or any combination thereof; and the prompt is further based on an additional instruction that the second generative AI model is to generate the response to the user request in accordance with the one or more response domains.

Aspect 6: The method of any of aspects 1 through 5, further comprising: providing the second generative AI model with an indication of a plurality of functions, wherein the one or more actions indicated in the pseudo-code expression of the generative AI behavioral policy correspond with one or more functions of the plurality of functions.

Aspect 7: The method of aspect 6, wherein the output of the second generative AI model includes one or more function calls to the one or more functions of the plurality of functions.

Aspect 8: The method of any of aspects 1 through 7, wherein the pseudo-code expression of the generative AI behavioral policy comprises conditional logic statements that correspond with one or more desired behaviors.

Aspect 9: The method of any of aspects 1 through 8, wherein the natural language description of the generative AI behavioral policy comprises an interaction history between a user and the first generative AI model; and the pseudo-code expression of the generative AI behavioral policy is based at least in part on the interaction history.

Aspect 10: The method of any of aspects 1 through 9, further comprising: recording one or more policy-based metrics that indicate a quantity of invocations of the generative AI behavioral policy, a quantity of modifications made to the generative AI behavioral policy, or both.

Aspect 11: The method of any of aspects 1 through 10, wherein the first generative AI model and the second generative AI model are a same generative AI model.

Aspect 12: An apparatus for data processing, comprising one or more memories storing processor-executable code, and one or more processors coupled with the one or more memories and individually or collectively operable to execute the code to cause the apparatus to perform a method of any of aspects 1 through 11.

Aspect 13: An apparatus for data processing, comprising at least one means for performing a method of any of aspects 1 through 11.

Aspect 14: A non-transitory computer-readable medium storing code for data processing, the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
transmitting, to a first generative artificial intelligence (AI) model, a request to convert a natural language description of a generative AI behavioral policy into a pseudo-code expression of the generative AI behavioral policy, wherein the generative AI behavioral policy describes one or more conditions and one or more actions that are to be performed based at least in part on satisfaction of at least one of the one or more conditions, dissatisfaction of at least one of the one or more conditions, or both;
transmitting, to a second generative AI model, a prompt generated based at least in part on the pseudo-code expression of the generative AI behavioral policy, a user request, and an instruction that the second generative AI model is to generate a response to the user request in accordance with the pseudo-code expression of the generative AI behavioral policy; and
receiving, from the second generative AI model and based at least in part on the prompt, an output of the second generative AI model, wherein the output conforms with the user request and the pseudo-code expression of the generative AI behavioral policy.

2. The method of claim 1, wherein the generative AI behavioral policy indicates one or more data inputs associated with the one or more actions.

3. The method of claim 1, further comprising:
transmitting, to the second generative AI model, a request indicating a previously-generated output of the second generative AI model, an operation history associated with generation of the previously-generated output, and an instruction for the second generative AI model to provide an analysis upon which a previously-generated output was based; and
incorporating one or more elements of the analysis into the natural language description of the generative AI behavioral policy.

4. The method of claim 1, further comprising:
providing the pseudo-code expression of the generative AI behavioral policy via a user interface; and
receiving user input modifying the pseudo-code expression of the generative AI behavioral policy.

5. The method of claim 1, wherein:
the generative AI behavioral policy is associated with one or more response domains, the one or more response domains comprising a knowledge domain, a frequency asked questions domain, a security quarantine domain, an escalation domain, or any combination thereof; and
the prompt is further based on an additional instruction that the second generative AI model is to generate the response to the user request in accordance with the one or more response domains.

6. The method of claim 1, further comprising:
providing the second generative AI model with an indication of a plurality of functions, wherein the one or more actions indicated in the pseudo-code expression of the generative AI behavioral policy correspond with one or more functions of the plurality of functions.

7. The method of claim 6, wherein the output of the second generative AI model includes one or more function calls to the one or more functions of the plurality of functions.

8. The method of claim 1, wherein the pseudo-code expression of the generative AI behavioral policy comprises conditional logic statements that correspond with one or more desired behaviors.

9. The method of claim 1, wherein:
the natural language description of the generative AI behavioral policy comprises an interaction history between a user and the first generative AI model; and
the pseudo-code expression of the generative AI behavioral policy is based at least in part on the interaction history.

10. The method of claim 1, further comprising:
recording one or more policy-based metrics that indicate a quantity of invocations of the generative AI behavioral policy, a quantity of modifications made to the generative AI behavioral policy, or both.

11. The method of claim 1, wherein the first generative AI model and the second generative AI model are a same generative AI model.

12. An apparatus for data processing, comprising:
one or more memories storing processor-executable code; and
one or more processors coupled with the one or more memories and individually or collectively operable to execute the code to cause the apparatus to:
transmit, to a first generative artificial intelligence (AI) model, a request to convert a natural language description of a generative AI behavioral policy into a pseudo-code expression of the generative AI behavioral policy, wherein the generative AI behavioral policy describes one or more conditions and one or more actions that are to be performed based at least in part on satisfaction of at least one of the one or more conditions, dissatisfaction of at least one of the one or more conditions, or both;
transmit, to a second generative AI model, a prompt generated based at least in part on the pseudo-code expression of the generative AI behavioral policy, a user request, and an instruction that the second generative AI model is to generate a response to the user request in accordance with the pseudo-code expression of the generative AI behavioral policy; and
receive, from the second generative AI model and based at least in part on the prompt, an output of the second generative AI model, wherein the output conforms with the user request and the pseudo-code expression of the generative AI behavioral policy.

13. The apparatus of claim 12, wherein the generative AI behavioral policy indicates one or more data inputs associated with the one or more actions.

14. The apparatus of claim 12, wherein the one or more processors are individually or collectively further operable to execute the code to cause the apparatus to:
transmit, to the second generative AI model, a request indicating a previously-generated output of the second generative AI model, an operation history associated with generation of the previously-generated output, and an instruction for the second generative AI model to provide an analysis upon which a previously-generated output was based; and
incorporate one or more elements of the analysis into the natural language description of the generative AI behavioral policy.

15. The apparatus of claim 12, wherein the one or more processors are individually or collectively further operable to execute the code to cause the apparatus to:
provide the pseudo-code expression of the generative AI behavioral policy via a user interface; and
receive user input modifying the pseudo-code expression of the generative AI behavioral policy.

16. The apparatus of claim 12, wherein:
the generative AI behavioral policy is associated with one or more response domains, the one or more response domains comprising a knowledge domain, a frequency asked questions domain, a security quarantine domain, an escalation domain, or any combination thereof; and
the prompt comprises an additional instruction that the second generative AI model is to generate the response to the user request in accordance with the one or more response domains.

17. The apparatus of claim 12, wherein the one or more processors are individually or collectively further operable to execute the code to cause the apparatus to:
provide the second generative AI model with an indication of a plurality of functions, wherein the one or more actions indicated in the pseudo-code expression of the generative AI behavioral policy correspond with one or more functions of the plurality of functions.

18. The apparatus of claim 17, wherein the output of the second generative AI model includes one or more function calls to the one or more functions of the plurality of functions.

19. The apparatus of claim 12, wherein:
the pseudo-code expression of the generative AI behavioral policy comprises conditional logic statements that correspond with one or more desired behaviors.

20. A non-transitory computer-readable medium storing code for data processing, the code comprising instructions executable by one or more processors to:
transmit, to a first generative artificial intelligence (AI) model, a request to convert a natural language description of a generative AI behavioral policy into a pseudo-code expression of the generative AI behavioral policy, wherein the generative AI behavioral policy describes one or more conditions and one or more actions that are to be performed based at least in part on satisfaction of at least one of the one or more conditions, dissatisfaction of at least one of the one or more conditions, or both;
transmit, to a second generative AI model, a prompt generated based at least in part on the pseudo-code expression of the generative AI behavioral policy, a user request, and an instruction that the second generative AI model is to generate a response to the user request in accordance with the pseudo-code expression of the generative AI behavioral policy; and
receive, from the second generative AI model and based at least in part on the prompt, an output of the second generative AI model, wherein the output conforms with the user request and the pseudo-code expression of the generative AI behavioral policy.
